(19) United States
(12) Patent Application Publication
(10) Pub. No.: US 2025/0056272 A1
(43) Pub. Date: Feb. 13, 2025

(54) DEVICES, METHODS, APPARATUSES, AND COMPUTER READABLE MEDIA FOR MEASURING MULTIPLE SECONDARY CELLS

(71) Applicant: Nokia Technologies Oy, Espoo (FI)

(72) Inventors: Lei DU, Beijing (CN); Lars DALSGAARD, Oulu (FI)

(21) Appl. No.: 18/773,115

(22) Filed: Jul. 15, 2024

(30) Foreign Application Priority Data
Aug. 8, 2023 (WO) PCT/CN2023/111779

(51) Int. Cl. H04W 24/08; H04W 76/28

(52) U.S. Cl. CPC H04W 24/08; H04W 76/28

(57) ABSTRACT

Disclosed are devices, methods, apparatuses, and computer readable media for measuring multiple secondary cells. An example apparatus for a terminal device may include at least one processor and at least one memory. The at least one memory may store instructions that, when executed by the at least one processor, may cause the terminal device at least to: receive configurations for discontinuous transmission defining active periods and non-active periods of multiple secondary cells, respectively; determine overlapping status of the active periods of the multiple secondary cells; determine, based on the determined overlapping status of the active periods of the multiple secondary cells, a measurement delay for measuring the multiple secondary cells; and measure the multiple secondary cells within the measurement delay.

### TECHNICAL FIELD

Various example embodiments relate to devices, methods, apparatuses, and computer readable media for measuring multiple secondary cells (SCells).

### BACKGROUND

Measuring a cell within a measurement delay may be the basis for data transmission of a user equipment (UE). If the UE is configured to measure multiple measurement objects (MOs) on carriers of multiple SCells, respectively, the UE is assumed able to measure only one cell of one carrier within one measurement occasion. Carrier specific scaling factor (CSSF) is introduced to scale the measurement delay when the UE is configured to measure/monitor multiple SCells. In a case where the measurement occasions are overlapping, the measurement delay may need to be extended by multiplying the value of the CSSF. On network (NW) side, cell discontinuous transmission (DTX), cell discontinuous reception (DRX), etc. have been introduced for network energy saving (NES). A cell DTX/DRX configuration defines an active period and a non-active (also referred to as an inactive) period of a cell. The cell DTX may also impact the measurement delay.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus for a terminal device. The apparatus may include at least one processor and at least one memory. The at least one memory may store instructions that, when executed by the at least one processor, may cause the terminal device at least to: receive configurations for discontinuous transmission defining active periods and non-active periods of multiple secondary cells, respectively; determine overlapping status of the active periods of the multiple secondary cells; determine, based on the determined overlapping status of the active periods of the multiple secondary cells, a measurement delay for measuring the multiple secondary cells; and measure the multiple secondary cells within the measurement delay.

In a second aspect, disclosed is an apparatus for a network device. The apparatus may include at least one processor and at least one memory. The at least one memory may store instructions that, when executed by the at least one processor, may cause the network device at least to: transmit, to a terminal device being served by the network device, configurations for discontinuous transmission defining active periods and non-active periods of multiple secondary cells, respectively, associated with the network device, wherein the active periods of the multiple secondary cells are separated in time.

In a third aspect, disclosed is a method performed by an apparatus for a terminal device. The method may comprise: receiving configurations for discontinuous transmission defining active periods and non-active periods of multiple secondary cells, respectively; determining overlapping status of the active periods of the multiple secondary cells; determining, based on the determined overlapping status of the active periods of the multiple secondary cells, a measurement delay for measuring the multiple secondary cells; and measuring the multiple secondary cells within the measurement delay.

In a fourth aspect, disclosed is a method performed by an apparatus for a network device. The method may comprise: transmitting, to a terminal device being served by the network device, configurations for discontinuous transmission defining active periods and non-active periods of multiple secondary cells, respectively, associated with the network device, wherein the active periods of the multiple secondary cells are separated in time.

In a fifth aspect, disclosed is an apparatus for a terminal device. The apparatus for the terminal device may comprise: means for receiving configurations for discontinuous transmission defining active periods and non-active periods of multiple secondary cells, respectively; means for determining overlapping status of the active periods of the multiple secondary cells; means for determining, based on the determined overlapping status of the active periods of the multiple secondary cells, a measurement delay for measuring the multiple secondary cells; and means for measuring the multiple secondary cells within the measurement delay.

In a sixth aspect, disclosed is an apparatus for a network device. The apparatus for the network device may comprise: means for transmitting, to a terminal device being served by the network device, configurations for discontinuous transmission defining active periods and non-active periods of multiple secondary cells, respectively, associated with the network device, wherein the active periods of the multiple secondary cells are separated in time.

In a seventh aspect, a computer readable medium is disclosed. The computer readable medium may comprise program instructions that, when executed by an apparatus for a terminal device, may cause the terminal device at least to perform: receiving configurations for discontinuous transmission defining active periods and non-active periods of multiple secondary cells, respectively; determining overlapping status of the active periods of the multiple secondary cells; determining, based on the determined overlapping status of the active periods of the multiple secondary cells, a measurement delay for measuring the multiple secondary cells; and measuring the multiple secondary cells within the measurement delay.

In an eighth aspect, a computer readable medium is disclosed. The computer readable medium may comprise program instructions that, when executed by an apparatus for a network device, cause the network device at least to perform: transmitting, to a terminal device being served by the network device, configurations for discontinuous transmission defining active periods and non-active periods of multiple secondary cells, respectively, associated with the network device, wherein the active periods of the multiple secondary cells are separated in time.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an example scenario to which the example embodiments of the present disclosure may be implemented.

FIG. 2 shows an exemplary sequence diagram for measuring multiple SCells according to the example embodiments of the present disclosure.

FIG. 3A shows an exemplary sequence diagram for measuring multiple SCells under an overlapping status according to the example embodiments of the present disclosure.

FIG. 3B shows an exemplary sequence diagram for measuring multiple SCells under another overlapping status according to the example embodiments of the present disclosure.

FIG. 4 shows a flow chart illustrating an example method 400 for measuring multiple SCells according to the example embodiments of the present disclosure.

FIG. 5 shows a flow chart illustrating an example method 500 for measuring multiple SCells according to the example embodiments of the present disclosure.

FIG. 6 shows a block diagram illustrating an example device 500 for measuring multiple SCells according to the example embodiments of the present disclosure.

FIG. 7 shows a block diagram illustrating an example device 700 for measuring multiple SCells according to the example embodiments of the present disclosure.

FIG. 8 shows a block diagram illustrating an example apparatus 800 for measuring multiple SCells according to the example embodiments of the present disclosure.

FIG. 9 shows a block diagram illustrating an example apparatus 900 for measuring multiple SCells according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for measuring multiple SCells. According to the example embodiments of the present disclosure, a UE may be allowed to measure multiple SCells in parallel pending on the cell DTX configurations, hence the measurement delay can be reduced.

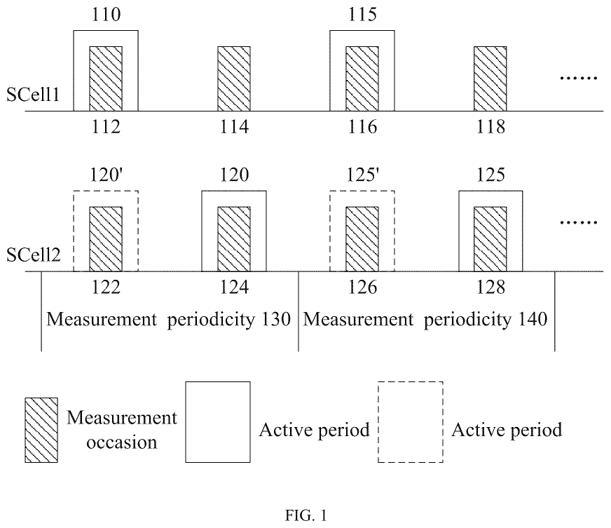

FIG. 1 shows an example scenario to which the example embodiments of the present disclosure may be implemented. Referring to the FIG. 1, assuming that a UE needs to measure a SCell1 and a SCell2, on measurement occasions 112, 114, 116, and 118, the UE may measure the SCell1, and on measurement occasions 122, 124, 126, and 128, the UE may measure the SCell2.

The FIG. 1 shows a disadvantageous scenario for measuring the SCell1 and the SCell2 where the measurement occasions 112, 114, 116, and 118 are overlapping with the measurement occasions 122, 124, 126, and 128, respectively, the UE has to measure the SCell1 and the SCell2 alternately because the measurement on the SCell1 would be delayed or interfered due to the measurement on the SCell2, and vice versa.

In the scenario shown in the FIG. 1, the SCell1 and the SCell2 have respective cell DTX configurations that may define different active (transmission) and inactive (no transmission) timings. The measurement occasions may be filtered by the cell DTX. For example, the UE may be assumed not measure the cell during the cell DTX non-active period when the cell is not transmitting. If as is shown in the FIG. 1, the SCell1 has active periods 110 and 115, and the SCell2 has active periods 120 and 125, the UE may measure the SCell1 on the measurement occasions 112 and 116 and measure the SCell2 on the measurement occasions 124 and 128. The measurement on the SCell1 would not be delayed or interfered due to the measurement on the SCell2 because of the cell DTX, and vice versa, thus, the measurements on the SCell1 and the SCell2 may be performed without interference.

The MOs measured may be for example the MOs for channel state information reference signals (CSI-RSs) of the SCells, synchronization signal blocks (SSBs) of the SCells, or both. A measurement object indicates parameters on which the measurement shall be carried out, such as a frequency/time location and subcarrier spacing of one or more reference signals to be measured. Those skilled in the art may understand that the example embodiments of the present disclosure may be implemented to measurement of other signal(s) of the SCells. The SSB may also refer to a synchronization signal and physical broadcast channel (PBCH) block. In the present disclosure, the term SSB or synchronization signal block may also refer to the synchronization signal and PBCH block.

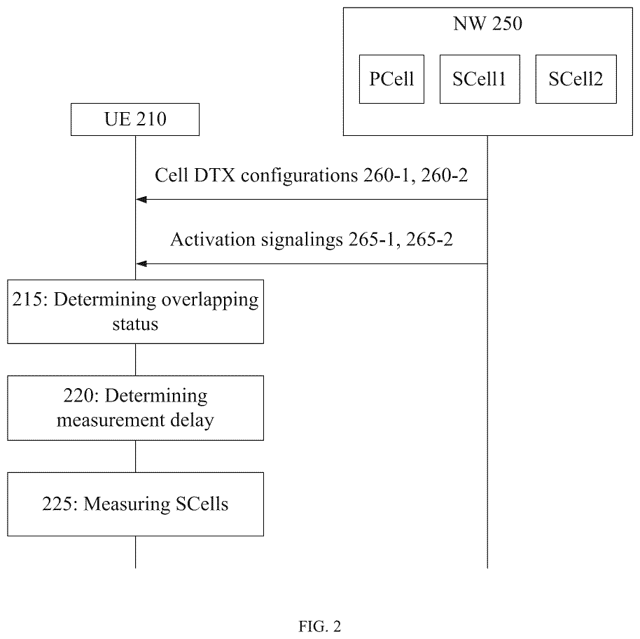

FIG. 2 shows an exemplary sequence diagram for measuring multiple SCells according to the example embodiments of the present disclosure. Referring to the FIG. 2, a UE 210 may represent any terminal device in a wireless network. On the network side, a primary cell (PCell), the SCell1 and the SCell2 (also shown in the FIG. 1) are serving the UE 210. The PCell, the SCell1, and the SCell2 may be associated with different network devices or the same network device. An exemplary network device 250 is shown in the FIG. 2 to collectively represent the network side serving the UE 210. The UE 210 may be in a radio resource control (RRC) connected mode with the network side.

The network device 250 may determine for the UE 210, configurations for DTX defining active periods and non-active periods of multiple SCells, respectively, and transmit the cell DTX configurations to the UE 210. In the present disclosure, two SCells, the SCell1 and the SCell2, are shown to represent the multiple SCells, and those skilled in the art may understand that the example embodiments of the present disclosure may be implemented to the scenario with more SCells.

Assuming that the DTX configuration of the SCell1 is denoted as 260-1, and the DTX configuration of the SCell2 is denoted as 260-2, the network device 250 may transmit the cell DTX configuration 260-1 and the cell DTX configuration 260-2 to the UE 210. In some embodiments, the network device 250 may activate the cell DTX configuration 260-1 on the SCell1 and the cell DTX configuration 260-2 on the SCell2 by using cell DTX configuration activation messages. Additionally, the network side, e.g. the SCell1 and the SCell2, may transmit to the UE 210 an activation signaling 265-1 and an activation signaling 265-2 to activate the cell DTX configuration 260-1 and the cell DTX configuration 260-2, respectively. The activation signaling 265-1 and an activation signaling 265-2 may be transmitted in different, e.g. later, messages than the message(s) delivering the cell DTX configuration 260-1 and the cell DTX configuration 260-2. The activation signaling 265-1 and the activation signaling 265-2 may inform the UE 210 the activation of the cell DTX configuration 260-1 and the activation of the cell DTX configuration 260-2, respectively.

Then, in an operation 215, the UE 210 may determine overlapping status of the active periods of the SCell1 and the SCell2. In an operation 220, based on the determined overlapping status of the active periods of the multiple secondary cells, the UE 210 may determine a measurement delay for measuring the SCell1 and the SCell2, and then in an operation 225, the UE 210 may measure the SCell1 and the SCell2 within the measurement delay.

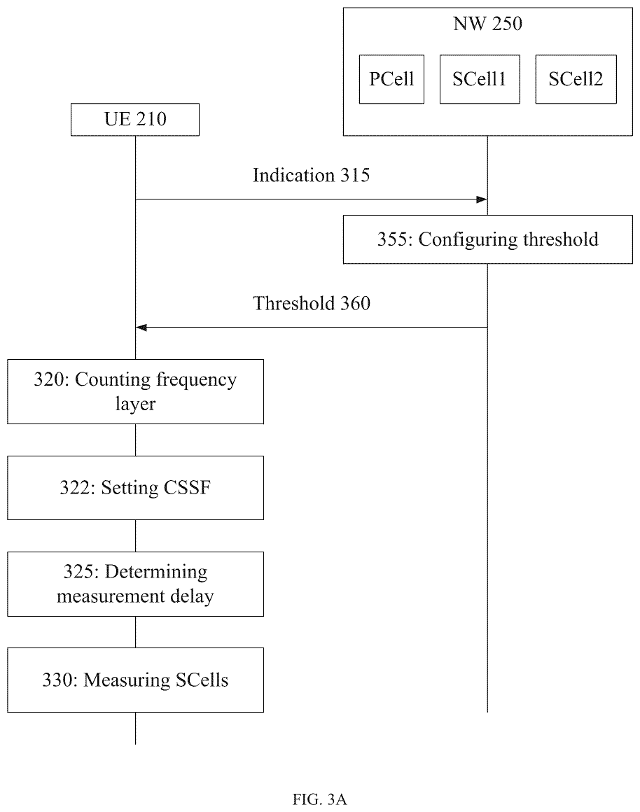

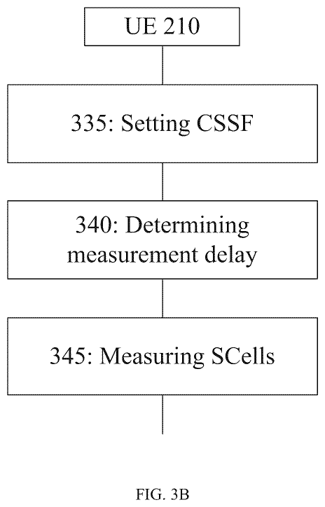

FIG. 3A shows an exemplary sequence diagram for measuring multiple SCells under an overlapping status according to the example embodiments of the present disclosure. The measurements on the multiple SCells shown in the FIG. 3A may be performed in a non-interference manner such that the measurement on one SCell is free from being delayed due to the measurement on another SCell. The non-interference manner may also be referred to as a manner without interference.

In some embodiments, if the overlapping status determined in the operation 215 is that the active periods of the multiple SCells are separated in time, for example, as is shown in the FIG. 1, the active period 110 and the active period 115 of the SCell1 are separated in time from the active period 120 and the active period 125 of the SCell2, the measurements during the active periods on the SCell1 and the SCell2 may be performed in the non-interference manner such that the measurement on the SCell1 will be free from being delayed (i.e. will not be delayed) due to the measurement on the SCell2, vice versa. In this scenario, thanks to the non-overlapping DTX active periods of the multiple SCells, the UE 210 can ‘hop’ between the different SCells to conduct the measurements, and the measurements can be made without causing any extra delay. As a consequence, the measurement delay requirement may be defined in the same way as for a situation where the UE 210 measures only a single cell. Hence, this is the non-interference manner for the measurements.

In some embodiments, the measurements during the active periods on the SCell1 and the SCell2 may be performed in the non-interference manner if the determined overlapping status is that the active periods of the SCell1 and the SCell2 are separated in time with a distance larger than a threshold. Threshold may be greater than zero. This is a bit stricter requirement than in the embodiment of the previous paragraph. For example, if the UE 210 has one searcher for the measurements on the SCell1 and the SCell2, referring to the FIG. 1, after the measurement during the active period 110 on the SCell1, the UE 210 may need a time period for switching the searcher from the SCell1 to the SCell2. The searcher may comprise radio frequency components and/or baseband components that require some time to carry out the switching. In this case, if the active period 120 and the active period 110 are separated in time with a distance larger than the time period for switching between the measurements on the SCell1 and the SCell2, the measurements during active period 120 and the active period 110 may be performed in the non-interference manner. Otherwise, if the active period 120 and the active period 110 are separated in time but shorter than the time period for switching between the measurements on the SCell1 and the SCell2, the measurements during active period 120 and the active period 110 may still be performed in an alternate manner, which will be described later. In this case, in the operation 215, the UE 210 may take the threshold, which may be larger than or equal to the time period for switching, into account, when determining the overlapping status. If the overlapping status indicates no overlap and there is the distance above the threshold, the measurements can be made in the non-interference manner, i.e. without causing any extra delay, and the measurement delay requirement may be maintained the same as for a single cell measurement.

In some embodiments, the threshold may be predefined in a standard, e.g. 5 ms. Alternatively in some embodiments, the threshold may be configured by the network device 250. For example, referring to the FIG. 3A, in an operation 355, the network device 250 may configure a threshold 360 for the UE 210 to determine in the operation 215 whether the overlapping status of the active periods of the SCell1 and the Scell2 is that the active periods of the Scell1 and the Scell2 are separated in time with a distance larger than the threshold. Then, the network device 250 may transmit the threshold 360 to the UE 210.

In some embodiments, the UE 210 may transmit to the network device 250 an indication 315 indicating the time period for switching between the measurements on the Scell1 and the Scell2 as a UE capability or a time value larger than the time period to allow some relaxation on UE implementation. Receiving the indication 315, in the operation 355, the network device 250 may configure the threshold 360 to be larger than or equal to the time period or the time value threshold for switching. Additionally in some embodiments, the network device 250 may determine and configure the cell DTX configurations 260-1 and 260-2 based on the time period. For example, the network device 250 may configure the active periods of the Scell1 and the Scell2 to be separated in time larger than the time period for switching, e.g. as separated as possible.

If the measurements during the active periods on the Scell1 and the Scell2 are performed in the non-interference manner, referring to the FIG. 1, the measurements during the active periods on the Scell1 and the Scell2 may be performed within one measurement periodicity. For example, within the measurement periodicity 130, the UE 210 may measure the Scell1 during the active period 110 and measure the Scell2 during the active period 120, and within the measurement periodicity 140, the UE 210 may measure the Scell1 during the active period 115 and measure the Scell2 during the active period 125.

Referring to the FIG. 3A, in an operation 320, the UE 210 may count Mos of the Scell1 and the Scell2 as one frequency layer when the measurements during the active periods on the Scell1 and the Scell2 are performed in the non-interference manner. As is shown in the FIG. 1, if the measurements during the active periods on the Scell1 and the Scell2 are performed in the non-interference manner, although the UE 210 actually measures two Scells, the Scell1 and the Scell2, the measurement duration or measurement delay is equivalent to the case that the UE 210 measures one Scell. If the UE 210 needs to measure five samples on the reference signal to be measured for a Scell and derive a measurement report based on the measured five samples, the measurement duration or measurement delay for measuring both the Scell1 and the Scell2 is equivalent to measurement duration or measurement delay for measuring one of the Scell1 or the Scell2. In this case, in the operation 320, the Mos of the Scell1 and the Scell2 may be counted as one frequency layer.

Alternatively or additionally, in an operation 322, the UE 210 may set a value of CSSF to be one when the measurements during the active periods on the Scell1 and the Scell2 are performed in the non-interference manner. As is shown in the FIG. 1, if the measurements during the active periods on the Scell1 and the Scell2 are performed in the non-interference manner, although the UE 210 actually measures two Scells, the Scell1 and the Scell2, the measurement duration or measurement delay is equivalent to the case that the UE 210 measures one Scell. If the UE 210 needs to measure five samples on the reference signal to be measured for a Scell and derive a measurement report based on the measured five samples, the measurement duration or measurement delay for measuring both the Scell1 and the Scell2 is equivalent to measurement duration or measurement delay for measuring one of the Scell1 or the Scell2. In this case, in the operation 322, the value of the CSSF is not scaled and may be set as one, i.e. CSSF=1.

Then, the operation 220 may be performed as an operation 325 in the FIG. 3A, in which the UE 210 may determine the measurement delay based on the number of the frequency layers. For the scenario shown in the FIG. 1, in which the measurements during the active periods on the Scell1 and the Scell2 are performed in the non-interference manner, the measurement delay is determined based on the number of the frequency layers. As the Mos on Scell1 and Scell2 are counted as one frequency layer in the example of the FIG. 3A, the number of the frequency layers is the same as the number of frequency layers when the UE 210 measures either Scell1 or Scell2, hence the measurement delay is not extended or scaled by the number of Mos or the Scells. Alternatively, the UE 210 may determine the measurement delay based on the value of the CSSF. As CSSF=1, hence the measurement delay is not extended or scaled by the CSSF.

Then, the operation 225 may be performed as an operation 330 in the FIG. 3A, in which the UE 210 may measure the Scell1 and the Scell2 during the active periods within the measurement delay in the non-interference manner.

FIG. 3B shows an exemplary sequence diagram for measuring multiple Scells under another overlapping status according to the example embodiments of the present disclosure. The measurements on the multiple Scells shown in the FIG. 3B may be performed in an alternate manner such that the measurement on one SCell is delayed due to the measurement on another SCell. Such a solution may cause extension to the determined measurement delay.

In some embodiments, if the overlapping status determined in the operation 215 is that the active periods of the multiple SCells are at least partially overlapping, for example, as is shown in the FIG. 1, assuming in this case the active periods of the SCell2 are active periods 120′ and 125′ but not the active periods 120 and 125, the measurements during the active periods on the SCell1 and the SCell2 may be performed in the alternate manner such that the measurement on the SCell1 will be delayed due to the measurement on the SCell2, vice versa.

In this case, the UE 210 may measure the SCell1 during the active period 110 within the measurement periodicity 130 and measure the SCell2 during the active period 125′ within the measurement periodicity 140, and the measurement on the SCell2 during the active period 120′ and the measurement on the SCell1 during the active period 115 are delayed.

Alternatively, the UE 210 may measure the SCell1 during the active period 110 within the measurement periodicity 130 and during the active period 115 within the measurement periodicity 140 as well as the following measurement periodicities to meet the sample number requirement for deriving the measurement report, and then measure the SCell2 during the following measurement periodicities to meet the sample number requirement for deriving the measurement report.

In a case where the UE 210 needs the time period for switching between the measurements on the SCell1 and the SCell2 as has been described above, the UE 210 may perform the measurements during the active periods on the SCell1 and the SCell2 in the alternate manner if the overlapping status is that the active periods of the SCell1 and the SCell2 are separated in time with a distance less than the threshold.

Referring to the FIG. 3B, in an operation 335, the UE 210 may set a value of CSSF according to the number of the multiple SCells where the determined overlapping status is that the active periods of the multiple SCells are at least partially overlapping. In the scenario shown in the FIG. 1, if the active periods of the SCell2 are active periods 120′ and 125′ but not the active periods 120 and 125, the UE 210 may set the value of the CSSF to be two, i.e. CSSF=2 as the active periods of the SCell1 and SCell2 are at least partially overlapping.

In a case where the UE 210 needs the time period for switching between the measurements on the SCell1 and the SCell2 as has been described above, in the operation 335, the UE 210 may set the value of the CSSF according to the number of the multiple SCells if the overlapping status is that the active periods of the multiple SCells are separated in time with a distance less than the threshold.

Then, the operation 220 may be performed as an operation 340 in the FIG. 3B, in which the UE 210 may determine the measurement delay based on the value of the CSSF. For example, the measurement delay may be scaled by the CSSF, e.g. doubled if CSSF=2.

Then, the operation 225 may be performed as an operation 345 in the FIG. 3B, in which the UE 210 may perform the measurements during the active periods on the SCell1 and the SCell2 within the determined measurement delay in the alternate manner.

Those skilled in the art may understand that the network side may be aware the UE behaviors by receiving messages from the UE, by presuming based on the messages from the UE, and/or based on the specifications in the standard.

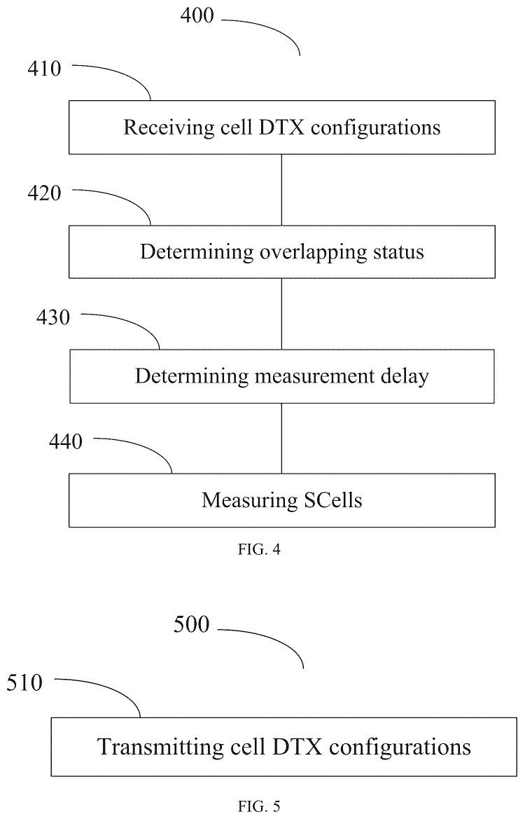

FIG. 4 shows a flow chart illustrating an example method 400 for measuring multiple SCells according to the example embodiments of the present disclosure. The example method 400 may be performed for example by an apparatus for a terminal device such as the UE 210 above mentioned.

Referring to the FIG. 4, the example method 400 may comprise: an operation 410 of receiving configurations for DTX defining active periods and non-active periods of multiple SCells, respectively; an operation 420 of determining overlapping status of the active periods of the multiple SCells; an operation 430 of determining, based on the determined overlapping status of the active periods of the multiple SCells, a measurement delay for measuring the multiple SCells; and an operation 440 of measuring the multiple SCells within the measurement delay.

Details of the operation 410 have been described in the above descriptions with respect to at least the cell DTX configurations 260-1 and 260-2, and repetitive descriptions thereof are omitted here.

Details of the operation 420 have been described in the above descriptions with respect to at least the operation 215, and repetitive descriptions thereof are omitted here.

Details of the operation 430 have been described in the above descriptions with respect to at least the operation 220, and repetitive descriptions thereof are omitted here.

Details of the operation 440 have been described in the above descriptions with respect to at least the operation 225, and repetitive descriptions thereof are omitted here.

In some embodiments, the example method 400 may include an operation of receiving from the multiple SCells, respective activation signalings to activate the configurations for the DTX. The more details have been described in the above descriptions with respect to at least the activation signalings 265-1 and 265-2, and repetitive descriptions thereof are omitted here.

In some embodiments, the example method 400 may include an operation of performing the measurements during the active periods on the respective SCells in a non-interference manner such that the measurement on one SCell is free from being delayed due to the measurement on another SCell if the determined overlapping status is that the active periods of the multiple SCells are separated in time. The more details have been described in the above descriptions with respect to at least the FIG. 1 and the operation 215, and repetitive descriptions thereof are omitted here.

In some embodiments, the example method 400 may include an operation of performing the measurements during the active periods on the respective SCells in the non-interference manner if the determined overlapping status is that the active periods of the multiple SCells are separated in time with a distance larger than a threshold. The more details have been described in the above descriptions with respect to at least the FIG. 1, the operation 215 and the threshold 360, and repetitive descriptions thereof are omitted here.

In some embodiments, the threshold may be predefined or configured by a network device. The more details have been described in the above descriptions with respect to at least the threshold 360 and the operation 355, and repetitive descriptions thereof are omitted here.

In some embodiments, the example method 400 may include an operation of transmitting to a network device an indication indicating a time period for switching between the measurements on the SCells. The more details have been described in the above descriptions with respect to at least the indication 315, and repetitive descriptions thereof are omitted here.

In some embodiments, the example method 400 may include an operation of performing the measurements during the active periods on the respective SCells within one measurement periodicity if the measurements during the active periods on the respective SCells are performed in the non-interference manner. The more details have been described in the above descriptions with respect to at least the FIG. 1, and repetitive descriptions thereof are omitted here.

In some embodiments, the example method 400 may include an operation of counting MOs of the multiple SCells as one frequency layer when the measurements during the active periods on the respective SCells are performed in the non-interference manner, and the measurement delay may be determined based on the number of the frequency layers. The more details have been described in the above descriptions with respect to at least the operations 320 and 325, and repetitive descriptions thereof are omitted here.

In some embodiments, the example method 400 may include an operation of performing the measurement during the active periods on the respective SCells in an alternate manner such that the measurement on one SCell is delayed due to the measurement on another SCell if the determined overlapping status is that the active periods of the multiple SCells are at least partially overlapping. The more details have been described in the above descriptions with respect to at least the FIG. 1 and the operation 215, and repetitive descriptions thereof are omitted here.

In some embodiments, the example method 400 may include an operation of setting a value of CSSF according to the number of the multiple SCells where the determined overlapping status is that the active periods of the multiple SCells are at least partially overlapping, and the measurement delay may be determined based on the value of the CSSF, and the measurements during the active periods on the multiple SCells may be performed in the alternate manner within the determined measurement delay. The more details have been described in the above descriptions with respect to at least the operations 335, 340 and 345, and repetitive descriptions thereof are omitted here.

In some embodiments, at least one of the following of the multiple SCells may be measured: CSI-RS, or SSB.

FIG. 5 shows a flow chart illustrating an example method 500 for measuring multiple SCells according to the example embodiments of the present disclosure. The example method 500 may be performed for example by an apparatus for a network device such as the network device 250 above mentioned.

Referring to the FIG. 5, the example method 500 may comprise: an operation 510 of transmitting, to a terminal device being served by the network device, configurations for DTX defining active periods and non-active periods of multiple SCells, respectively, associated with the network device, wherein the active periods of the multiple secondary cells are separated in time.

Details of the operation 510 have been described in the above descriptions with respect to at least at least the cell DTX configurations 260-1 and 260-2, and repetitive descriptions thereof are omitted here.

In some embodiments, the example method 500 may include an operation of configuring a threshold for the terminal device to determine whether the overlapping status of the active periods of the multiple SCells is that the active periods of the multiple SCells are separated in time with a distance larger than the threshold. The more details have been described in the above descriptions with respect to at least the operations 215 and 355 and the threshold 360, and repetitive descriptions thereof are omitted here.

In some embodiments, the example method 500 may include an operation of receiving from the terminal device an indication indicating a time period for switching between measurements on the SCells, and the configurations for the discontinuous transmission may be determined based on the time period. The more details have been described in the above descriptions with respect to at least the indication 315 and the cell DTX configurations 260-1 and 260-2, and repetitive descriptions thereof are omitted here.

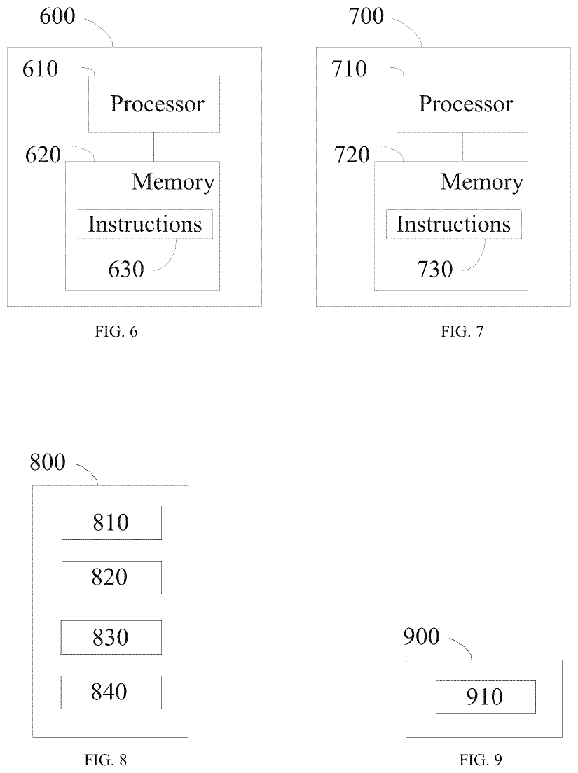

FIG. 6 shows a block diagram illustrating an example device 500 for measuring multiple SCells according to the example embodiments of the present disclosure. The device, for example, may be at least part of an apparatus for a terminal device such as the UE 210 in the above examples.

As shown in the FIG. 6, the example device 600 may include at least one processor 610 and at least one memory 620 that may store instructions 630. The instructions 630, when executed by the at least one processor 610, may cause the device 600 at least to perform the example method 3400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 210 is not limited to the above example device 600.

FIG. 7 shows a block diagram illustrating an example device 700 for measuring multiple SCells according to the example embodiments of the present disclosure. The device, for example, may be at least part of an apparatus for a network device such as the network device 250 in the above examples.

As shown in the FIG. 7, the example device 700 may include at least one processor 710 and at least one memory 720 that may store instructions 730. The instructions 730, when executed by the at least one processor 710, may cause the device 700 at least to perform the example method 500 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 250 is not limited to the above example device 700.

FIG. 8 shows a block diagram illustrating an example apparatus 800 for measuring multiple SCells according to the example embodiments of the present disclosure. The apparatus, for example, may be at least part of a terminal device such as the UE 210 in the above examples.

As shown in the FIG. 8, the example apparatus 800 may comprise: means 810 for receiving configurations for DTX defining active periods and non-active periods of multiple SCells, respectively; means 820 for determining overlapping status of the active periods of the multiple SCells; means 830 for determining, based on the determined overlapping status of the active periods of the multiple SCells, a measurement delay for measuring the multiple SCells; and means 840 for measuring the multiple SCells within the measurement delay.

In some embodiments, the apparatus 800 may comprise means for receiving from the multiple SCells, respective activation signalings to activate the configurations for the DTX.

In some embodiments, the apparatus 800 may comprise means for performing the measurements during the active periods on the respective SCells in a non-interference manner such that the measurement on one SCell is free from being delayed due to the measurement on another SCell if the determined overlapping status is that the active periods of the multiple SCells are separated in time.

In some embodiments, the apparatus 800 may comprise means for performing the measurements during the active periods on the respective SCells in the non-interference manner if the determined overlapping status is that the active periods of the multiple SCells are separated in time with a distance larger than a threshold.

In some embodiments, the threshold may be predefined or configured by a network device.

In some embodiments, the apparatus 800 may comprise means for transmitting to a network device an indication indicating a time period for switching between the measurements on the SCells.

In some embodiments, the apparatus 800 may comprise means for performing the measurements during the active periods on the respective SCells within one measurement periodicity if the measurements during the active periods on the respective SCells are performed in the non-interference manner.

In some embodiments, the apparatus 800 may comprise means for counting MOs of the multiple SCells as one frequency layer when the measurements during the active periods on the respective SCells are performed in the non-interference manner, and the measurement delay may be determined based on the number of the frequency layers.

In some embodiments, the apparatus 800 may comprise means for performing the measurement during the active periods on the respective SCells in an alternate manner such that the measurement on one SCell is delayed due to the measurement on another SCell if the determined overlapping status is that the active periods of the multiple SCells are at least partially overlapping.

In some embodiments, the apparatus 800 may comprise means for setting a value of CSSF according to the number of the multiple SCells where the determined overlapping status is that the active periods of the multiple SCells are at least partially overlapping, and the measurement delay may be determined based on the value of the CSSF, and the measurements during the active periods on the multiple SCells may be performed in the alternate manner within the determined measurement delay.

In some embodiments, at least one of the following of the multiple SCells may be measured: CSI-RS, or SSB.

In some example embodiments, examples of means in the example apparatus 800 may include circuitries. For example, an example of means 810 may include a circuitry configured to perform the operation 410 of the example method 400, an example of means 820 may include a circuitry configured to perform the operation 420 of the example method 400, an example of means 830 may include a circuitry configured to perform the operation 430 of the example method 400, and an example of means 840 may include a circuitry configured to perform the operation 440 of the example method 400.

The example apparatus 800 may further include means comprising circuitry configured to perform the example method 400. In some example embodiments, examples of means may also include software modules and any other suitable function entities.

FIG. 9 shows a block diagram illustrating an example apparatus 900 for measuring multiple SCells according to the example embodiments of the present disclosure. The apparatus, for example, may be at least part of a network device such as the network device 250 in the above examples.

As shown in the FIG. 9, the example apparatus 900 may comprise: means 910 for transmitting, to a terminal device being served by the network device, configurations for DTX defining active periods and non-active periods of multiple SCells, respectively, associated with the network device, wherein the active periods of the multiple secondary cells are separated in time.

In some embodiments, the apparatus 900 may comprise means for configuring a threshold for the terminal device to determine whether the overlapping status of the active periods of the multiple SCells is that the active periods of the multiple SCells are separated in time with a distance larger than the threshold.

In some embodiments, the apparatus 900 may comprise means for receiving from the terminal device an indication indicating a time period for switching between measurements on the SCells, and the configurations for the discontinuous transmission may be determined based on the time period.

In some example embodiments, examples of means in the example apparatus 900 may include circuitries. For example, an example of means 910 may include a circuitry configured to perform the operation 510 of the example method 500.

The example apparatus 900 may further include means comprising circuitry configured to perform the example method 500. In some example embodiments, examples of means may also include software modules and any other suitable function entities.

The example embodiments of the present disclosure also provide a computer readable medium comprising program instructions that, when executed by an apparatus for a terminal device such as the UE 210 in the above examples, may cause the terminal device at least to: receive configurations for DTX defining active periods and non-active periods of multiple SCells, respectively; determine overlapping status of the active periods of the multiple SCells; determine, based on the determined overlapping status of the active periods of the multiple SCells, a measurement delay for measuring the multiple SCells; and measure the multiple SCells within the measurement delay.

In some embodiments, the computer readable medium may include instructions that, when executed by the apparatus, may cause the terminal device to: receive from the multiple SCells, respective activation signalings to activate the configurations for the DTX.

In some embodiments, the computer readable medium may include instructions that, when executed by the apparatus, may cause the terminal device to: perform the measurements during the active periods on the respective SCells in a non-interference manner such that the measurement on one SCell is free from being delayed due to the measurement on another SCell if the determined overlapping status is that the active periods of the multiple SCells are separated in time.

In some embodiments, the computer readable medium may include instructions that, when executed by the apparatus, may cause the terminal device to: perform the measurements during the active periods on the respective SCells in the non-interference manner if the determined overlapping status is that the active periods of the multiple SCells are separated in time with a distance larger than a threshold.

In some embodiments, the threshold may be predefined or configured by a network device.

In some embodiments, the computer readable medium may include instructions that, when executed by the apparatus, may cause the terminal device to: transmit to a network device an indication indicating a time period for switching between the measurements on the SCells.

In some embodiments, the computer readable medium may include instructions that, when executed by the apparatus, may cause the terminal device to: perform the measurements during the active periods on the respective SCells within one measurement periodicity if the measurements during the active periods on the respective SCells are performed in the non-interference manner.

In some embodiments, the computer readable medium may include instructions that, when executed by the apparatus, may cause the terminal device to: count MOs of the multiple SCells as one frequency layer when the measurements during the active periods on the respective SCells are performed in the non-interference manner, and the measurement delay may be determined based on the number of the frequency layers.

In some embodiments, the computer readable medium may include instructions that, when executed by the apparatus, may cause the terminal device to: perform the measurement during the active periods on the respective SCells in an alternate manner such that the measurement on one SCell is delayed due to the measurement on another SCell if the determined overlapping status is that the active periods of the multiple SCells are at least partially overlapping.

In some embodiments, the computer readable medium may include instructions that, when executed by the apparatus, may cause the terminal device to: set a value of CSSF according to the number of the multiple SCells where the determined overlapping status is that the active periods of the multiple SCells are at least partially overlapping, and the measurement delay may be determined based on the value of the CSSF, and the measurements during the active periods on the multiple SCells may be performed in the alternate manner within the determined measurement delay.

In some embodiments, at least one of the following of the multiple SCells may be measured: CSI-RS, or SSB.

The example embodiments of the present disclosure also provide a computer readable medium comprising program instructions that, when executed by an apparatus for a network device such as the network device 250 in the above examples, may cause the network device at least to: transmit, to a terminal device being served by the network device, configurations for DTX defining active periods and non-active periods of multiple SCells, respectively, associated with the network device, wherein the active periods of the multiple secondary cells are separated in time.

In some embodiments, the computer readable medium may include instructions that, when executed by the apparatus, may cause the network device to: configure a threshold for the terminal device to determine whether the overlapping status of the active periods of the multiple SCells is that the active periods of the multiple SCells are separated in time with a distance larger than the threshold.

In some embodiments, the computer readable medium may include instructions that, when executed by the apparatus, may cause the network device to receive from the terminal device an indication indicating a time period for switching between measurements on the SCells, and the configurations for the discontinuous transmission may be determined based on the time period.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
CSI-RS channel state information reference signal
CSSF carrier specific scaling factor
DRX discontinuous reception
DTX discontinuous transmission
MO measurement object
NES network energy saving
NW network
PBCH physical broadcast channel
PCell primary cell
RRC radio resource control
SCell secondary cell
SSB synchronization signal block
   synchronization signal and PBCH block
UE user equipment

What is claimed is:

1. An apparatus for a terminal device, comprising:
at least one processor; and
at least one memory storing instructions that, when executed by the at least one processor, cause the terminal device at least to:
receive configurations for discontinuous transmission defining active periods and non-active periods of multiple secondary cells, respectively;
determine overlapping status of the active periods of the multiple secondary cells;
determine, based on the determined overlapping status of the active periods of the multiple secondary cells, a measurement delay for measuring the multiple secondary cells; and
measure the multiple secondary cells within the measurement delay.

2. The apparatus of claim 1, wherein the apparatus is configured to:
receive from the multiple secondary cells, respective activation signalings to activate the configurations for the discontinuous transmission.

3. The apparatus of claim 1, wherein the apparatus is configured to:
perform the measurements during the active periods on the respective secondary cells in a non-interference manner such that the measurement on one secondary cell is free from being delayed due to the measurement on another secondary cell if the determined overlapping status is that the active periods of the multiple secondary cells are separated in time.

4. The apparatus of claim 3, wherein the apparatus is configured to:
perform the measurements during the active periods on the respective secondary cells in the non-interference manner if the determined overlapping status is that the active periods of the multiple secondary cells are separated in time with a distance larger than a threshold.

5. The apparatus of claim 4, wherein
the threshold is predefined or configured by a network device.

6. The apparatus of claim 4, wherein the apparatus is configured to:
transmit to a network device an indication indicating a time period for switching between the measurements on the secondary cells.

7. The apparatus of claim 3, wherein the apparatus is configured to:
perform the measurements during the active periods on the respective secondary cells within one measurement periodicity if the measurements during the active periods on the respective secondary cells are performed in the non-interference manner.

8. The apparatus of claims 3, wherein the apparatus is configured to:
count measurement objects of the multiple secondary cells as one frequency layer when the measurements during the active periods on the respective secondary cells are performed in the non-interference manner, and
the measurement delay is determined based on the number of the frequency layers.

9. The apparatus of claim 1, wherein the apparatus is configured to:
perform the measurement during the active periods on the respective secondary cells in an alternate manner such that the measurement on one secondary cell is delayed due to the measurement on another secondary cell if the determined overlapping status is that the active periods of the multiple secondary cells are at least partially overlapping.

10. The apparatus of claim 9, wherein the apparatus is configured to:
set a value of carrier specific scaling factor according to the number of the multiple secondary cells where the determined overlapping status is that the active periods of the multiple secondary cells are at least partially overlapping, and
the measurement delay is determined based on the value of the carrier specific scaling factor, and
the measurements during the active periods on the multiple secondary cells are performed in the alternate manner within the determined measurement delay.

11. The apparatus of claim 1, wherein at least one of the following of the multiple secondary cells are measured:
channel state information reference signal, or
synchronization signal block.

12. An apparatus for a network device, comprising:
at least one processor; and
at least one memory storing instructions that, when executed by the at least one processor, cause the network device at least to:
transmit, to a terminal device being served by the network device, configurations for discontinuous transmission defining active periods and non-active periods of multiple secondary cells, respectively, associated with the network device, wherein
the active periods of the multiple secondary cells are separated in time.

13. The apparatus of claim 12, wherein the apparatus is configured to:
configure a threshold for the terminal device to determine whether the overlapping status of the active periods of the multiple secondary cells is that the active periods of the multiple secondary cells are separated in time with a distance larger than the threshold.

14. The apparatus of claim 13, wherein the apparatus is configured to:
receive from the terminal device an indication indicating a time period for switching between measurements on the secondary cells, and
the configurations for the discontinuous transmission are determined based on the time period.

15. A method performed by an apparatus for a terminal device, comprising:
receiving configurations for discontinuous transmission defining active periods and non-active periods of multiple secondary cells, respectively;
determining overlapping status of the active periods of the multiple secondary cells;
determining, based on the determined overlapping status of the active periods of the multiple secondary cells, a measurement delay for measuring the multiple secondary cells; and
measuring the multiple secondary cells within the measurement delay.

16. The method of claim 15, comprising:
receiving from the multiple secondary cells, respective activation signalings to activate the configurations for the discontinuous transmission.

17. The method of claim 15, comprising:
performing the measurements during the active periods on the respective secondary cells in a non-interference manner such that the measurement on one secondary cell is free from being delayed due to the measurement on another secondary cell if the determined overlapping status is that the active periods of the multiple secondary cells are separated in time.

18. The method of claim 17, comprising:
performing the measurements during the active periods on the respective secondary cells in the non-interference manner if the determined overlapping status is that the active periods of the multiple secondary cells are separated in time with a distance larger than a threshold.

19. The method of claim 18, comprising:
transmitting to a network device an indication indicating a time period for switching between the measurements on the secondary cells.

20. The method of claim 17, comprising:
performing the measurements during the active periods on the respective secondary cells within one measurement periodicity if the measurements during the active periods on the respective secondary cells are performed in the non-interference manner.
